(19) United States
(12) Patent Application Publication
(10) Pub. No.: US 2002/0093286 A1
(43) Pub. Date: Jul. 18, 2002

(54) Organic EL display and method for producing the same

(75) Inventors: Isamu Ohshita, Yamagata (JP); Teruichi Watanabe, Yamagata (JP)

Correspondence Address: SUGHRUE MION, PLLC, 2100 Pennsylvania Avenue, NW, Washington, DC, 20037-3213, US

(73) Assignee: TOHOKU PIONEER CORPORATION

(21) Appl. No.: 10/041,668

(22) Filed: Jan. 10, 2002

(30) Foreign Application Priority Data
Jan. 12, 2001 (JP) P.2001-004640

(51) Int. Cl. H01J 1/62; H01J 63/04

(52) U.S. Cl. 313/506; 313/504

(57) ABSTRACT

In a method of forming organic EL display, after ITO films 13 and TFT layers 14 are disposed on the transparent substrate 11 via an inter-layer insulating film 12, mask supporting layers 18 are disposed on the inter-layer insulating film 12, and the metal mask 19 of a predetermined pattern is overlaid on the transparent substrate 11 so as to be supported by the supporting layers 18. The organic EL thin film 16 and the cathode thin film 17 are deposited on the ITO films 13 through openings of the metal mask 19.

### BACKGROUND OF THE INVENTION

1. Field of the Invention

The present invention relates to an organic electroluminescent (EL) display having improved anti-leaking characteristics, and a method of producing such a display.

2. Description of the Related Art

In an organic EL display, an image is displayed by means of spontaneous light which is generated by applying a voltage to a luminescent layer, and therefore is brighter and clearer than that obtained in a liquid crystal display that requires a back light, and not susceptible to a viewing angle. Because of these advantages, attention is focused on an organic EL display as a next-generation display device.

The system of driving an organic EL display is roughly classified into the simple matrix system and the active matrix system.

In the simple matrix system, an X-Y matrix structure is employed in which ITO electrodes (anodes) and cathodes are formed in a stripe form so as to perpendicularly cross one another. In order to attain insulation between an organic luminescent layer and the cathodes in the Y-Y direction, occasionally, a cathode barrier layer is formed in advance of vapor deposition of the cathodes. The simple matrix driving requires a higher instantaneous brightness as the duty ratio of the driving is higher, with the result that the driving voltage is raised and the luminous efficiency is lowered.

By contrast, in the active matrix system, a TFT circuit and a capacitor are connected to each of the ITO electrodes, and the voltage is maintained by the holding capacitance of the capacitor. Therefore, the same voltage can be always applied to the electrode during one frame, and hence a 100%-duty driving is enabled. Furthermore, the system has advantages that elements have a prolonged life period, and that the power consumption can be suppressed to a small value.

A simple matrix organic EL element in which a cathode barrier layer is employed is produced in the following manner. An ITO (anode) thin film 2 is disposed on a transparent substrate 1, and then patterned into a stripe form in the X-X direction. Thereafter, a cathode barrier layer 3 is formed on the ITO thin film 2, and patterned into a stripe form in the Y-Y direction. Next, an organic luminescent layer 4 and a cathode thin film 5 are deposited on the ITO thin film 2 by the vapor deposition method (FIG. 1).

Because the organic luminescent layer 4 is easily affected by chemicals, patterning based on etching cannot be applied to the formation of the layered structure. In the vapor deposition of the organic luminescent layer 4 and the cathode thin film 5, therefore, a metal mask 6 of a predetermined pattern is put on the transparent substrate 1, and pressed against the transparent substrate 1 by a magnetic force due to a magnet 7. As a result, the metal mask 6 is closely contacted with the cathode barrier layer 3, so that the organic luminescent layer 4 and the cathode thin film 5 are prevented from being formed with straddling the cathode barrier layer 3. Since the cathode barrier layer 3 is placed between the metal mask 6 and the transparent substrate 1, it is possible to avoid also a direct contact between the mask and the substrate (FIG. 2).

By contrast, in an active matrix organic EL element, a thin film structure in which the cathode barrier layer 3 is not necessary is employed, and hence there is a possibility that the metal mask 6 is in direct contact with the transparent substrate 1. When the metal mask 6 is in contact with the transparent substrate 1, a trouble that causes a light emission abnormality or a leak, such as a damage of a light emitting face or adhesion of dust occurs.

The direct contact between the transparent substrate 1 and the metal mask 6 similarly occurs also in a simple matrix organic EL element in which the cathode barrier layer 3 is not employed, in the same manner as in an active matrix organic EL element.

### SUMMARY OF THE INVENTION

The invention has been conducted in order to solve the problems. It is an object of the invention to provide an organic EL display in which an insulative mask supporting layer is disposed on a transparent substrate, whereby a metal mask is prevented from being in contact with the transparent substrate, to avoid occurrence of a defect that causes a light emission abnormality or a leak, and which can therefore exhibit excellent luminous characteristics.

In order to attain the object, the organic EL display of the invention is an organic EL display wherein the display comprises: ITO films which are disposed on a transparent substrate via an inter-layer insulating film; an insulating film which is disposed between adjacent ones of the ITO films; and an organic EL thin film and a cathode thin film which are deposited on the ITO films, and insulative mask supporting layers constitute a part of or a whole of the insulating film, the mask supporting layers preventing a metal mask which is used in formation of the organic EL thin film and the cathode thin film, from being in contact with a pixel portion of the transparent substrate.

As the substrate, a TFT substrate may be used in which the ITO films and TFT layers that are disposed via the inter-layer insulating film are connected to one another in an active matrix system. The mask supporting layers which are different from the insulating film is formed by applying or sputtering a resist, ceramics, or an organic resin. In the case where the mask supporting layers are disposed on the insulating film, preferably, the mask supporting layers are formed into a reverse tapered shape. The mask supporting layers may be patterned in a subsequent photolithography step or the like. The metal mask is prevented by the mask supporting layers from being in contact with the surface of the ITO film or the organic EL thin film on the ITO film, i.e., a pixel portion.

The organic EL display can be produced by: disposing the ITO films on the transparent substrate via the inter-layer insulating film; then disposing the mask supporting layers on the inter-layer insulating film; overlaying the metal mask of a predetermined pattern on the transparent substrate so as to be supported by the mask supporting layers; and depositing the organic EL thin film and the cathode thin film on the ITO films through openings of the metal mask. In place of the transparent substrate, a TFT substrate in which the ITO films and the TFT layers that are disposed via the inter-layer insulating film are connected to one another in an active matrix system may be used.

### BRIEF DESCRIPTION OF THE DRAWINGS

FIG. 1 is a diagram of steps producing a simple matrix organic EL element.

FIG. 2 is a view showing a state where a metal mask is overlaid on a transparent substrate.

FIG. 3 is a view showing the section structure of an organic EL element according to the invention.

FIG. 4 is a section view showing a state where a metal mask is overlaid on a TFT substrate via mask supporting layers.

FIGS. 5A to 5D are views showing examples of a stacked structure having mask supporting layers, respectively.

### DETAILED DESCRIPTION OF THE PREFERRED EMBODIMENTS

Now, a description will be given in more detail of preferred embodiments of the invention with reference to the accompanying drawings.

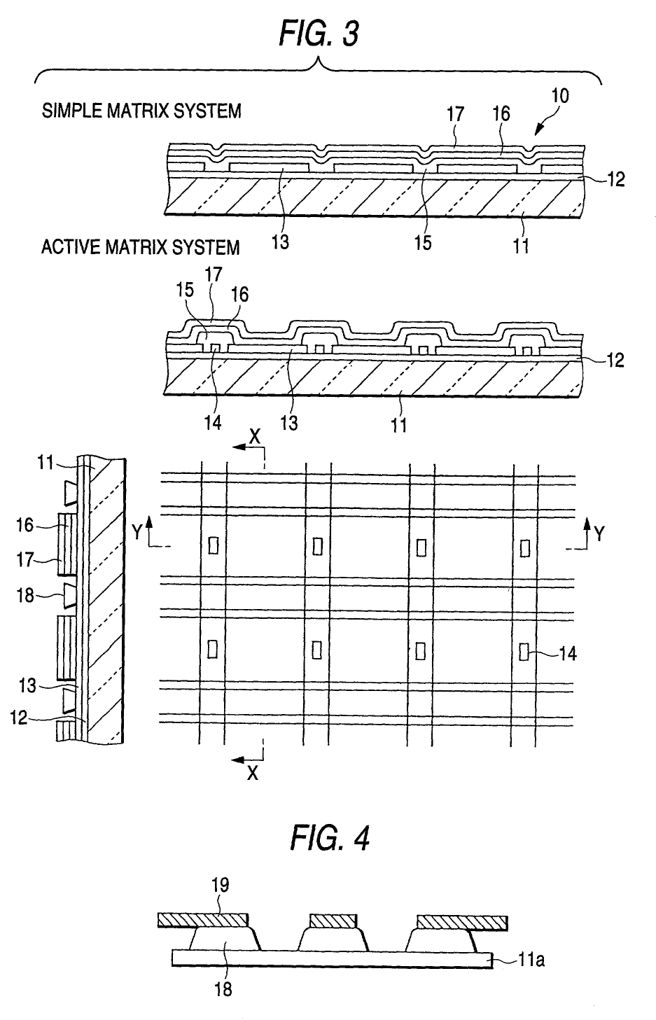

In an active matrix organic EL element 10 according to the invention, as shown in the section structure in FIG. 3, ITO (anodes) films 13, TFT layers 14, and an organic EL thin film 16 are formed on a transparent substrate 11 via an inter-layer insulating film 12. An insulating film 15 is deposited to prevent short circuits between the ITO film 13/the ITO film 13, the ITO film 13/the TFT layer 14, the TFT layer 14/a cathode thin film 17, and the ITO film 13/the cathode thin film 17 from occurring. An organic EL thin film 16 including a hole transporting layer, an organic luminescent layer, and an electron transporting layer is formed on the ITO films 13 and the insulating film 15. Thereafter, the cathode thin film 17 is disposed by, for example, vapor deposition of A1.

When a driving current is supplied between one of the ITO films 13 which elongate in a stripe form along the X-X direction, and the cathode thin film 17 which elongates in the Y-Y direction to perpendicularly cross the film, holes from the anode and electrons from the cathode are recombined in the organic EL thin film 16 corresponding to a specific pixel, to excite organic illuminant molecules, thereby causing surface luminescence.

In the formation of the organic EL thin film 16 and the cathode thin film 17, insulative mask supporting layers 18 are formed on a substrate (hereinafter, referred to as TFT substrate 11a) which is configured by disposing the ITO films 13, the TFT layers 14, and the insulating film 15 on the transparent substrate 11 (FIG. 4).

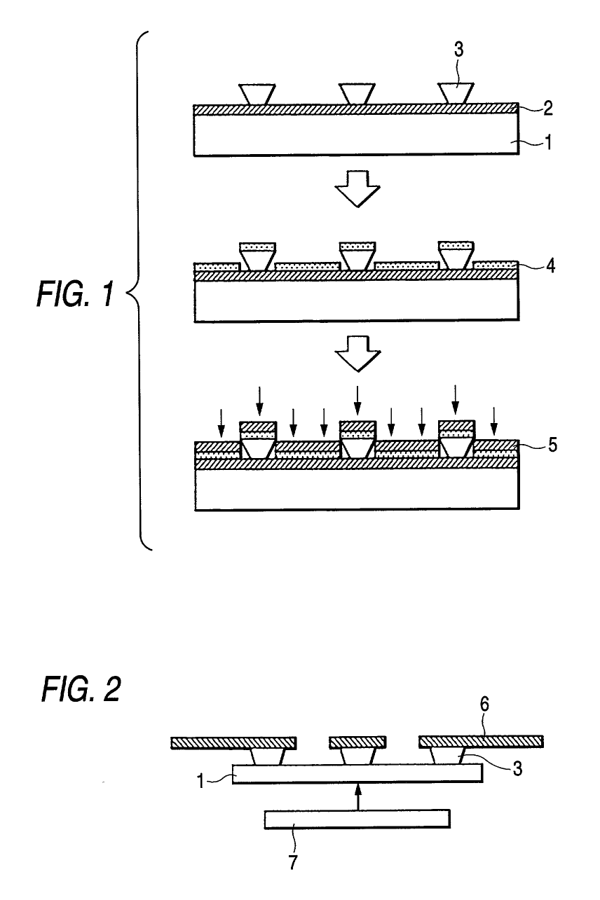

The mask supporting layers 18 are used for avoiding direct contact of the metal mask 19 with the transparent substrate 11. Unlike the conventional cathode barrier layer 3 (FIG. 1) which is used for separating the cathode, the mask supporting layers are not required to be formed into a reverse tapered shape as far as a predetermined gap is maintained between the transparent substrate 11 the metal mask 19. An arbitrary number of the mask supporting layers in the form of a stripe or an island can be disposed in any places on the TFT substrate 11a.

The mask supporting layers 18 are formed by applying or sputtering one of various kinds of resist, ceramics such as silica or alumina, or an organic resin such as a polyimide resin or an acrylic resin in a predetermined pattern. Alternatively, the layers may be patterned in the subsequent photolithography step or the like. The height of the mask supporting layers 18 depends on the tolerance of unsharpness of selective application or the like. In order to prevent the metal mask 19 from being in contact with the TFT substrate 11a, it is preferably to form the mask supporting layers so as to have a thickness of 2 μm or more.

The section shape of the mask supporting layers 18 is not particularly restricted, and has any shape such as a reverse tapered shape or a ridge type. The mask supporting layers 18 may be formed so as to cover the TFT layer 14 in order to prevent short circuits between the ITO films 13 and the TFT layers 14 from occurring. The mask supporting layers 18 may be disposed in advance of the formation of the insulating film 15.

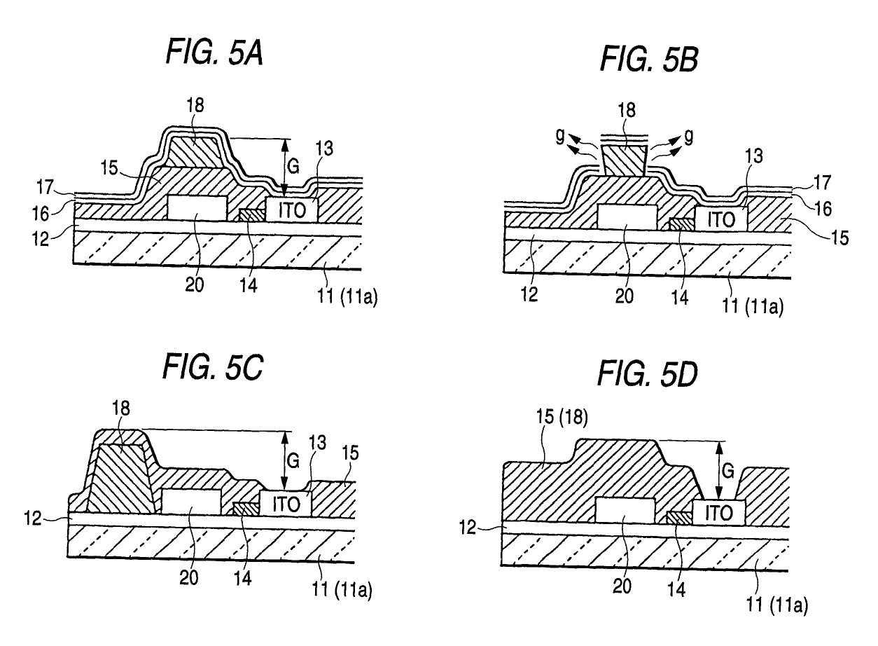

Specifically, the TFT substrate 11a in which the ITO films 13, the TFT layers 14, and metal wirings 20 are formed in a predetermined arrangement on the transparent substrate 11 that is covered by the inter-layer insulating film 12 is prepared. The insulating film 15 is disposed so that the principal faces of the ITO films 13 are exposed. Thereafter, the mask supporting layers 18 are stacked on the insulating film 15 (FIG. 5A). The height of the top face of each of the mask supporting layers 18 is set so that, when the mask supporting layers 18 contactingly support the metal mask 19, a gap G of several μm is formed between the corresponding ITO film 13 and the metal mask 19 in the case of the stacking of the first layer of the EL film, and between an (n−1)-th layer of the EL film and the metal mask 19 in the case of the stacking of an n-th layer of the EL film.

In the case where the mask supporting layers 18 are disposed on raised portions of the insulating film 15, it is preferable to form the mask supporting layers 18 into a reverse tapered shape (FIG. 5B). In the case of the mask supporting layers 18 of a reverse tapered shape, the organic EL thin film 16 and the cathode thin film 17 are not stacked in the vicinity of the basal portion of each mask supporting layer. Therefore, a function of promoting dissipation of a gas g which is generated from various insulating materials by heat applied in the formation of the organic EL thin film 16 and the cathode thin film 17 is exerted. Since the dissipation of the gas g occurs in a place where the cathode thin film 17 is divided, deterioration of the organic EL thin film 16 is suppressed.

The mask supporting layers 18 may be formed directly on the inter-layer insulating film 12 disposed on the TFT substrate 11a, and thereafter the insulating film 15 may be stacked so as to cover the mask supporting layers 18 (FIG. 5C). Alternatively, the mask supporting layers 18 may be formed by locally thickening parts of the insulating films 15 (FIG. 5D). In any case, the height of the top face of each of the insulating film 15 stacked on the mask supporting layers 18 (FIG. 5C), or that of the top face of the insulating film 15 in the thickest portion (FIG. 5D) is set so that the predetermined gap G is maintained between the corresponding ITO film 13 or the (n−1)-th layer of the EL film and the metal mask 19.

When the metal mask 19 is overlaid on the TFT substrate 11a, a contact between the metal mask 19 and the TFT substrate 11a is prevented from occurring, by the formation of the mask supporting layers 18. Under this state, the organic EL thin film 16 and the cathode thin film 17 are disposed between adjacent ones of the mask supporting layers 18. Therefore, it is possible to obtain the organic EL element 10 that is free from a defect which causes a light emission abnormality or a leak. The mask supporting layers 18 constitute a part of the insulating film 15 which insulates the ITO films 13 from the TFT layers 14.

Also in the production of a simple matrix organic EL element in which the cathode barrier layer 3 (FIG. 1) is not disposed, the mask supporting layers 18 exert the function of preventing the metal mask 6 from being in contact with the transparent substrate 1. In this case, an arbitrary number of the mask supporting layers 18 having an arbitrary section shape can be disposed in any places on the transparent substrate 1. In this case, it is a matter of course that the mask supporting layers 18 are disposed in places and a shape by which the cathode thin film 17 is not divided.

### EXAMPLE

Optical glass was used as the transparent substrate 11. A polyimide resin was spin-coated on the surface of the transparent substrate 11 to form the inter-layer insulating film 12 of a thickness of 1 μm. The ITO films 13 and the TFT layers 14 were formed on the inter-layer insulating film 12 in the usual manner, and drain lines and power source lines were connected to one another to constitute an active matrix. In a simple matrix organic EL element, the TFT layers 14 can be omitted.

Then, a polyimide resin was spin-coated so as to cover the TFT substrate 11a with leaving a surface portion of the ITO film 13 uncovered, to dispose the mask supporting layers 18 of a thickness of 2 μm. When the metal mask 19 of a predetermined pattern was overlaid on the TFT substrate 11a, the gap between the TFT substrate 11a and the metal mask 19 was maintained to 2 μm by the mask supporting layers 18, and the metal mask 19 was not in contact with the TFT substrate 11a.

The organic EL thin film 16 and the cathode thin film 17 were deposited on the ITO films 13 via the metal mask 19. As the organic EL thin film 16, a hole transporting layer, a luminescent layer, and an electron transporting layer were sequentially deposited by a conventional vapor depositing method. It is a matter of course that, alternatively, an organic EL thin film of the single- or two-layer structure may be formed.

The metal mask 19 was removed away, and Al was vapor-deposited on the organic EL thin film 16, thereby obtaining the organic EL element 10 in which the cathode thin film 17 of a thickness of 100 nm is disposed.

A panel which is configured by the organic EL element 10, and which has dots of 100×100 was sealed in the atmosphere of an inert gas (N₂). Then, the panel was subjected to a heat cycle test of −40 to 85° C. while all dots were lit at a brightness of 100 cd/m². As a result, in the panel in which the mask supporting layers 18 are formed, the frequency at which a light emission abnormality or a leak occurs after the test was drastically reduced to about several tenths of that in a panel in which the mask supporting layers 18 are not formed. The test result shows that the organic EL element 10 of high quality which is excellent in quality stability can be produced by forming the mask supporting layers 18.

As described above, in the organic EL display of the invention, the organic EL thin film and the cathode thin film are deposited without causing the metal mask to be in contact with the transparent substrate. Therefore, a damage of a light emitting face or adhesion of dust which is caused by a contact of the metal mask does not occur, and hence the organic EL display exhibits excellent luminous characteristics. Unlike a cathode barrier layer in the conventional art, moreover, the mask supporting layers which separate the metal mask from the transparent substrate are not required to be accurately disposed. Consequently, the production process can be simplified. As a result, an organic EL display of high performance can be produced economically and easily.

What is claimed is:

1. An organic electroluminescent (EL) display, comprising:
a plurality of ITO films which are disposed on a transparent substrate via an inter-layer insulating film;
an insulating film which is disposed between adjacent ones of said ITO films;
an organic EL thin film deposited on said ITO films;
a cathode thin film deposited on said ITO films; and
a plurality of insulative mask supporting layers constituting a part of or a whole of said insulating film, said mask supporting layers preventing a metal mask which is used in formation of said organic EL thin film and said cathode thin film, from being in contact with a pixel portion of said transparent substrate.

2. The organic EL display according to claim 1, wherein said display uses a TFT substrate in which said ITO films and TFT layers that are disposed via said inter-layer insulating film are connected to one another in an active matrix system.

3. The organic EL display according to claim 1, wherein said mask supporting layers are formed by one of a resist, ceramics and an organic resin.

4. The organic EL display according to claim 1, wherein said insulative mask supporting layers having a reverse tapered shape are disposed on said insulating film.

5. A method of producing an organic EL display, said method comprising the steps of:
disposing a plurality of ITO films on a transparent substrate via an inter-layer insulating film;
disposing a plurality of mask supporting layers on said inter-layer insulating film;
overlaying a metal mask of a predetermined pattern having openings therein on said transparent substrate so as to support said metal mask by said mask supporting layers; and
depositing an organic EL thin film and a cathode thin film on said ITO films through the openings of said metal mask.

6. The method of producing an organic EL display according to claim 5, further comprising the steps of:
disposing said ITO films and TFT layers on said transparent substrate via said inter-layer insulating film;
connecting said ITO films and said TFT layers to one another in an active matrix system; and
then forming said mask supporting layer.
